(19) United States
(12) Patent Application Publication
(10) Pub. No.: US 2008/0182132 A1
(43) Pub. Date: Jul. 31, 2008

(54) Determining the cleanliness of a part used in manufacturing by selectively detecting particles substantially comprised of hard contaminant

(76) Inventors: Yiqi Feng, Singapore (SG); Hui Yan Hu, Singapore (SG); Siew Wah Sum, Singapore (SG); Yi Zhao Yao, Singapore (SG)

Correspondence Address: HITACHI C/O WAGNER BLECHER LLP, 123 WESTRIDGE DRIVE, WATSONVILLE, CA, 95076, US

(21) Appl. No.: 11/700,472

(22) Filed: Jan. 30, 2007

(51) Int. Cl. G11B 5/33; G01N 15/00

(52) U.S. Cl. 428/810; 73/865.5

(57) ABSTRACT

Embodiments of the present invention pertain to determining the cleanliness of a part used in manufacturing by selectively detecting particles substantially comprised of hard contaminant. According to one embodiment, filtered particles captured on a filter are received at a selective particle detection device. The selective particle detection device determines if at least one of the filtered particles is substantially comprised of hard contaminant. Examples of hard contaminant include silicate, carbide, and ceramic. The determination does not require detecting particles which are not substantially comprised of hard contaminant.

### TECHNICAL FIELD

Embodiments of the present invention relate to manufacturing hard disk drives. More specifically, embodiments of the present invention relate to determining the cleanliness of a part used in manufacturing by selectively detecting particles substantially comprised of hard contaminant.

### BACKGROUND

Manufacturing disk drives is a very competitive business. People that buy disk drives are demanding more and more for their money. For example, they want disk drives that are more reliable and have more capabilities. One way to provide more capabilities is to make the various disk drive components smaller. One way to make disk drives more reliable is to improve the cleanliness of the parts used in manufacturing the disk drive.

Typically a hard disk drive (HDD) uses an actuator assembly for positioning read/write heads at the desired location of a disk to read data from and/or write data to the disk. The read/write heads can be mounted on what is known as a slider. Generally, a slider provides mechanical support for a read/write head and electrical connections between the head and the drive. Typically, the closer that the slider can glide over a disk's surface the higher the density that data can be stored on the disk's surface.

However, the closer that a slider glides over the disk's surface, the more prone the disk's surface is to damage. For example, the rotation of a disk around the spindle causes air to move beneath a slider. The slider can glide over the moving air at a uniform distance above the surface of the rotating disk, thus, avoiding contact between the read/write head and the surface of the disk. As disk drives are handled during the manufacturing process, particles from various sources can be generated. A particle can cause damage to the disk if the particle comes between the slider's air bearing surface and the disk. This is just one example of how particles can cause damage to a hard disk drive.

### SUMMARY OF THE INVENTION

Embodiments of the present invention pertain to determining the cleanliness of a part used in manufacturing by selectively detecting particles substantially comprised of hard contaminant. According to one embodiment, filtered particles captured on a filter are received at a selective particle detection device. The selective particle detection device determines if at least one of the filtered particles is substantially comprised of hard contaminant. Examples of hard contaminant include silicate, carbide, and ceramic. The determination does not require detecting particles which are not substantially comprised of hard contaminant.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a plan view of a disk drive for facilitating the discussion of various embodiments of the present invention.

FIG. 2 depicts a diagram of an apparatus used to extract hard particles from a part, according to one embodiment.

FIG. 3 depicts a diagram of an apparatus used for extracting hard particles from a part, according to another embodiment.

FIG. 4 depicts an apparatus for filtering hard particles from the solution, according to one embodiment.

FIG. 5 depicts a block diagram of a selective particle detection device, according to one embodiment.

FIG. 6 depicts a flowchart describing a method for determining the cleanliness of a part used in manufacturing by selectively detecting particles substantially comprised of hard contaminant, according to one embodiment.

The drawings referred to in this description should not be understood as being drawn to scale except if specifically noted.

### DETAILED DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

Parts, such as HDD components and tools used to manufacture HDDs, are typically lapped during the manufacturing process in order to clean and to provide smooth surfaces on the parts. The materials that are used in lapping include silicon carbide (SiC). The process of lapping can result in particles that are substantially comprised of silicon carbide. Silicon carbide is an example of a ceramic and a hard contaminate. Examples of hard contaminates include, but are not limited to, silicates, carbides, and ceramics. Particles that are substantially made of hard contaminant are considered by the industry to be “hard particles” which can cause substantial damage to a hard disk drive for example if a hard particle comes between a slider and a disk's surface. Therefore, it is important to determine the cleanliness of parts used in manufacturing. If the cleanliness is not adequate, then actions can be taken to improve the cleanliness.

However, conventional methods of assessing cleanliness are time consuming, typically taking several hours. Disk drives can be sold at lower prices when they are manufactured more quickly. Therefore, the company that can manufacture disk drives the quickest has a significant competitive advantage over their competitors. According to one embodiment, particle analysis can be performed in approximately 10 minutes instead of several hours, for example, by selectively detecting particles that are substantially made of hard contaminate. Although many of the embodiments described herein refer to a ceramic, such as silicon carbide, various embodiments can be used for any type of hard contaminant.

### A Disk Drive

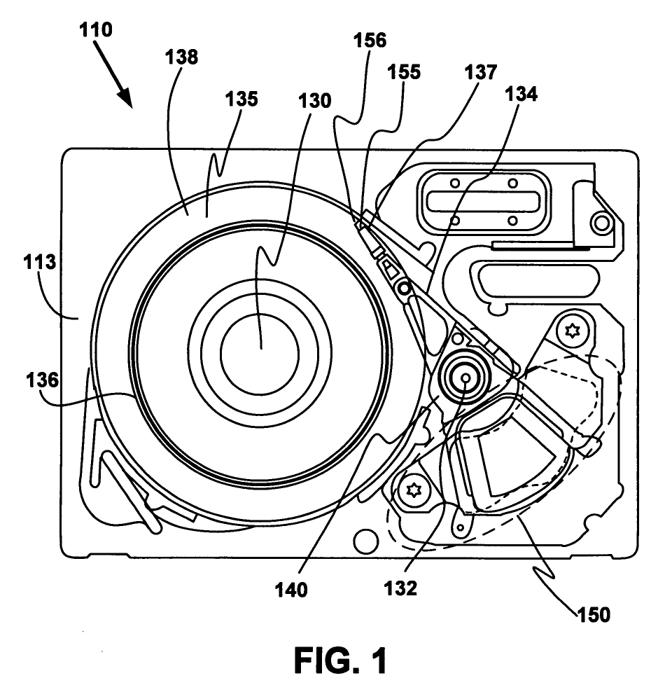

FIG. 1 depicts a plan view of a disk drive for facilitating the discussion of various embodiments of the present invention. The disk drive 110 includes a base casting 113, a motor hub assembly 130, a disk 138, actuator shaft 132, actuator arm 134, suspension assembly 137, a hub 140, voice coil motor 150, a magnetic head 156, and a slider 155.

The components are assembled into a base casting 113, which provides attachment and registration points for components and sub assemblies. A plurality of suspension assemblies 137 (one shown) can be attached to the actuator arms 134 (one shown) in the form of a comb. A plurality of transducer heads or sliders 155 (one shown) can be attached respectively to the suspension assemblies 137. Sliders 155 are located proximate to the disk 138's surface 135 for reading and writing data with magnetic heads 156 (one shown). The rotary voice coil motor 150 rotates actuator arms 135 about the actuator shaft 132 in order to move the suspension assemblies 150 to the desired radial position on a disk 138. The actuator shaft 132, hub 140, actuator arms 134, and voice coil motor 150 may be referred to collectively as a rotary actuator assembly.

Data is recorded onto the disk's surface 135 in a pattern of concentric rings known as data tracks 136. The disk's surface 135 is spun at high speed by means of a motor-hub assembly 130. Data tracks 136 are recorded onto spinning disk surfaces 135 by means of magnetic heads 156, which typically reside at the end of sliders 155.

FIG. 1 being a plan view shows only one head, slider and disk surface combination. One skilled in the art understands that what is described for one head-disk combination applies to multiple head-disk combinations, such as disk stacks (not shown). However, for purposes of brevity and clarity, FIG. 1 only shows one head and one disk surface.

### Extracting Hard Particles From A Part

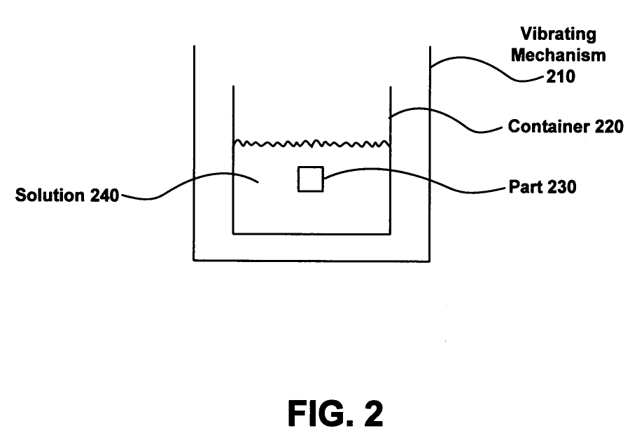

FIG. 2 depicts a diagram of an apparatus used to extract hard particles made substantially of hard contaminant from a part, according to one embodiment. As depicted in FIG. 2, a container 220 includes solution 240 that a part 230 is submerged in. The container 220 is placed in a vibrating mechanism 210 that causes the container 220 and solution 240 to vibrate. A vibrating mechanism 210 can be an ultrasonic tank. The vibration causes hard particles substantially comprised of hard contaminant to come off of the part 230 so that the solution 240 will include at least a portion of the hard particles that were on the part 230. The solution 240 can be filtered through one or more filters. The particles on the filter can be analyzed to determine if there are any hard particles made substantially of hard contaminant.

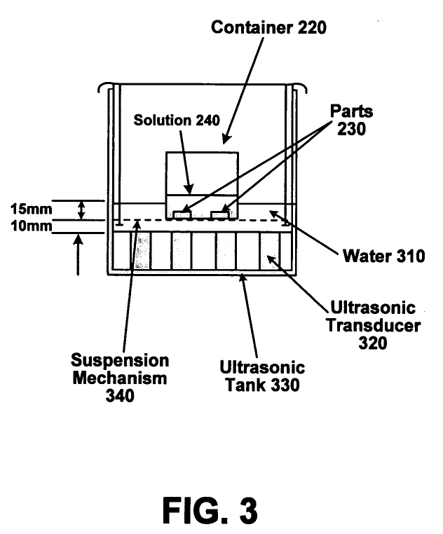

FIG. 3 depicts a diagram of an apparatus used for extracting hard particles from a part, according to another embodiment. The vibrating mechanism includes an ultrasonic tank 330 with an ultrasonic transducer 320. As depicted in FIG. 3, a suspension mechanism 340 can be used so that the bottom of the container 220 is approximately 10 millimeters (mm) above the ultrasonic transducer 320. For example, the suspension mechanism 340 may be a mesh or a perforated plate. The water level of the water 310 in vibrating mechanism may be slightly below the solution 240's surface level.

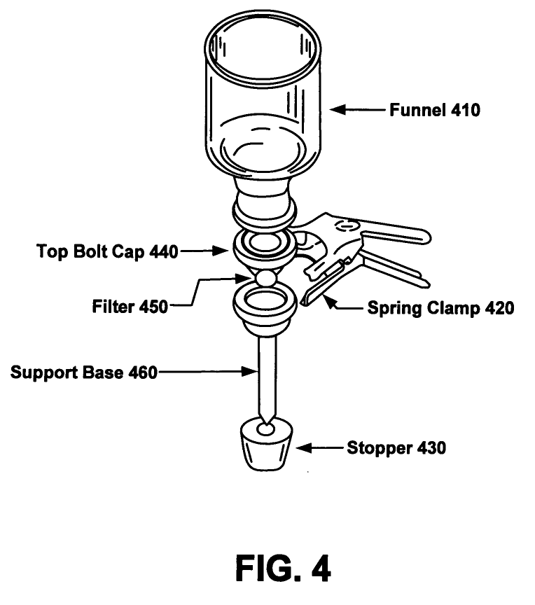

FIG. 4 depicts an apparatus for filtering hard particles from the solution, according to one embodiment. The apparatus as depicted in FIG. 4 includes a funnel 410, a top bolt cap 440, a filter 450, a spring clamp 420, a support base 460, and a stopper 430. The funnel 410 can be a borosilicate glass funnel, the top bolt cap 440 can be a pomalux top bolt cap, the filter 450 can be a polycarbonate membrane with a diameter of 13 mms, the spring clamp 420 can be an anodized aluminum spring clamp, and the support base 460 can be a Teflon™ filter support base. The solution 240 with the hard particles can be poured into the funnel 410 to filter the hard particles from the solution 240 through the filter 450.

After the particles have been filtered through one or more filters 450, the filters 450 can be dried. For example, a filter 450 can be transferred to a carbon sticky stub. The filter 450 can be dried over night at room temperature or dried under an infrared (IR) lamp using IR radiation for approximately 30 minutes to 1 hour in a clean room environment.

### Parts

The term “parts” shall refer to any HDD component or manufacturing tool used in assembling the HDD components. Refer to the description of FIG. 1 for several examples of HDD components. A spacer ring is also an example of an HDD component. Examples of manufacturing tools used to assemble HDD components include any type of robotic hand for picking up HDD components and assembling them together. Assembling HDD components involves, among other things, manufacturing tools moving around the HDD components and coming into contact with the HDD components. Hard particles on a manufacturing tool may be transferred to the disk drive when the manufacturing tool comes into contact with the HDD component. Further hard particles on a manufacturing tool may fall off of the tool, for example, as the tool moves above an HDD component.

### Solution

According to one embodiment, the solution 240 is used to remove particles from a part. For example, the solution can include water from the manufacturing site's treatment plant. The water is di-ionized to remove ion contaminates, according to one embodiment. The solution may include a fixed amount of detergent, such as 0.004% Micro-90 detergent. The detergent, according to one embodiment, facilitates removal of the particles from the part.

### Container

According to one embodiment, the container 220 is used for containing solution that a part can be submerged in. According to one embodiment, the container is a clean beaker. For example the clean beaker may be approximately 110 milliliters (ml) to 400 ml. According to another embodiment, the container can be a stainless steel container.

### Filters

The filters 450 may be polyethylene, polypropylene, or polycarbonate. The pore size can range from approximately 0.3 microns to 0.8 microns. The diameter may be approximately 1.5 cm. Spot sizes of approximately 2 mm or 3 mm can be used.

### The Vibrating Mechanism

According to one embodiment, the vibrating mechanism 210 is an ultrasonic tank, such as a Branson 40 kilohertz (kHz) ultrasonic tank. According to one embodiment, approximately 40-90% output of the ultrasonic tank and approximately 30 kilohertz (kHz) to 300 kHz for approximately 60 seconds are used. According to another embodiment, approximately 80% output of the ultrasonic tank and 40 kHz for approximately 60 seconds are used.

### Selective Particle Detection Device

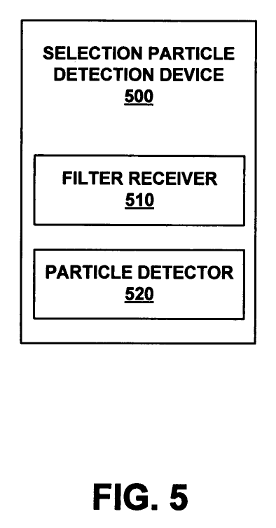

FIG. 5 depicts a block diagram of a selective particle detection device, according to one embodiment. As depicted in FIG. 2, the selective particle detection device 500 includes a filter receiver 510 and a particle detector 520. According to one embodiment, the device 500 is a SEM/EDX system. The scanning electron microscope (SEM) part of the device 500 may be a Leo 1430 LaB6 SEM and the EDX part of the device 500 may be a LEO 1550 field emissions SEM energy dispersive X-ray (EDX) analyzer or an EDAX phoenix microanalyzer EDX system. An EDS may be used instead of the EDX.

The filter receiver 510 can receive one or more filters with associated particles. For example, a filter can be mounted on a sticky stub and placed in the device. The particle detector 520 can detector whether any of the particles associated with the filter are particles substantially made of hard contaminant. For example, the device 500 can be configured to selectively detect particles that are substantially made of hard contaminant, as will become more evident. The device 500 can also be configured to detect particles made substantially of hard contaminant. Examples of hard contaminant include silicates, carbides, ceramic, or a combination thereof. Further, the device 500 can detect the particles made substantially of hard contaminant without requiring full analysis. The particles associated with the filter can be analyzed using backscatter mode. EDX analysis can be used to identify and quantify the total number of particles on the filter.

### Values For Configuring The Selective Particle Detection Device

As already stated, the device can be configured to selectively detect particles that are substantially made of hard contaminant. Table 1 depicts values that can be used to configure a device 500 as depicted in FIG. 5 to perform SEM analysis. Table 2 depicts values that can be used to configure the device 500 to perform EDX analysis.

TABLE 1
values that can be used to configure a device as depicted in FIG. 5 to
perform SEM analysis, according to one embodiment

| Value | | | |
|---|---|---|---|
| reference | Version | | |
| No. | No. | Control Panel | Values |
| 1 | 1.0 | SEM | |
| 2 | 1.1 | GUN | EHT = 20 kV |
| 3 | | | Spot size = 460 |
| 4 | | | Filament I = 1.95 A |
| 5 | 1.2 | Detector BSD | AutoBS = Off |
| 6 | | | Brightness = 75% |
| 7 | | | Contrast = 80% |
| 8 | 1.3 | Aperture | 50 um |
| 9 | 1.4 | Scanning | Speed = 3 (cycle time = 334 ms) |
| 10 | 1.5 | QBSD Control | 1–4 = Normal |
| 11 | | | BSD Auto range = selected |
| 12 | | | BSD Fast = Selected |
| 13 | | | BSD Gain: any |
| 14 | 1.6 | Microscope | WD = 15 mm |
| 15 | | | Mag = 500x |

TABLE 2
values that can be used to configure the device to perform EDX analysis,
according to one embodiment

| Value | | | |
|---|---|---|---|
| reference | Version | | |
| No. | No. | Control Panel | Values |
| 16 | 2.0 | EDX | |
| 17 | 2.1 | Microscope | Mag = 1000 |
| | | Control | |
| 18 | | | Wd = 15 mm |
| 19 | | | KV = 20 kV |
| 20 | 2.2 | Job | Stub area = 2.0 × 2.0 |
| | | Automation | |
| 21 | | | Field size = 0.119 × 0.089 mm, 12 |
| | | | fields |
| 22 | | Control Panels | Use values to configure the |
| | | | selective particle detection device |
| | | | as described herein. For example, |
| | | | refer to the description under |
| | | | subheading “Values for |
| | | | Configuring the Selective Particle |
| | | | Detection Device” and the |
| | | | description of flowchart 600. |
| 23 | 2.3 | Analysis Setup | Preset = 5 Sec |
| 24 | | | Mode = clock |
| 25 | | | Amp time = 17 us |
| 26 | | | Data type = ZAF |
| 27 | | | Particle scan = core 80% |
| 28 | | | Save spectrum = yes |
| 29 | | | Include border particle = yes |
| 30 | | | Threshold Erosion = 1 |
| 31 | 2.4 | Image | Matrix = 514 × 400 |
| | | Collection | |
| 32 | | | Strip = 1 |
| 33 | 2.5 | Threshold | 130–220 |
| 34 | | | Size-0.3–50 um |
| 25 | | | Phase = 1 |

According to one embodiment, spot size (value reference no. 3), brightness (value reference no 6) and contrast (value reference no. 7) are configured to achieve a desired level of brightness. For example, a spotsize of 460, brightness of 75% and contrast of 80% may be used. Although these 3 values are one example, other values may be used depending on SEM conditions and filament history. Brightness selection can be set to make particles made substantially of hard contaminant visible by backscatter detector (BSD) under the combined parameter settings. For example, for SiC detection, the BSD settings may be brighter than what is conventionally used for metallic particle detection.

With regards to field number (value reference no. 21), according to one embodiment, 4×3×2 (2 locations on 12 fields) is used for a spot size of 2.0 mm on the filter. According to one embodiment, a field factor less than 15 or the area analyzed by EDX is not less than 6.7% of the total area. Once the field number is selected, the field numbers analyzed can be fixed. Correlation can be done if any change is made to the SEM or EDX settings. For example, an amp time (value reference no. 25) of 10 us to 17 us may in many cases be used for particle analysis.

The amp time (value reference no. 25), according to one embodiment, is set to result in a dead time of EDX that is less than 30%. The spot size (value reference no. 3) can be increased or the filament changed, according to one embodiment, in order to achieve EDX signal abundance (CPS) that is greater than 1000. The BSD Gain (value reference no. 13) may be set to change automatically. The Magnification (value reference no. 17) can be set to approximately 1000. The threshold erosion (value reference no. 30) can be set to 1, the threshold (value reference no. 33) can be approximately 130-220, and the threshold size (value reference no. 34) can be approximately 0.3-50 um.

Although Table 1 and 2 depict examples of values for configuring a device 500 to selectively detect particles that are substantially made of hard contaminant, other values may be used. For example, it may be desirable to use different values for the spot size (value reference no. 3) and the contrast (value reference no. 7) than what are depicted in Tables 1 and 2 as a part of selectively detecting particles that are substantially made of hard contaminant.

### Calculating Results

After analyzing the filters, for example using auto analysis, the device 500 may display the number of particles (also referred to as “raw number”) that it counted. The following is a description of one way of calculating the final number of particles based on the raw number of particles. N_{final} represents the final number of particles substantially made of hard contaminant on a filter. N_{d} represents the raw number of particles detected. N_{final} can be calculated using the following formula, according to one embodiment:

N_{final}=N_{d}Sₜ/Sₐ

For example, if the spot size diameter is 3.0 mm and 12 fields were analyzed, the area analyzed would equal 0.119×0.089×12 which equals 0.1271 mm̂2. The area factor (Sₜ/Sₐ) would equal 7.0684/0.1271 which equals 55.6. If however two locations were analyzed, the area factor would be 27.8 (55.6/2). In another example, if the spot size diameter is 2.0 mm and 12 fields were analyzed, the area analyzed would equal 0.119×0.089×12 2 which would equal 0.1271 mm̂2. The area factor (Sₜ/Sₐ) would equal 3.14/0.1271 which equals 24.7. If two locations were analyzed, the area factor would be 12.35 (24.7/2).

### Method Of Selectively Detecting Particles That Are Substantially Made Of Hard Contaminant

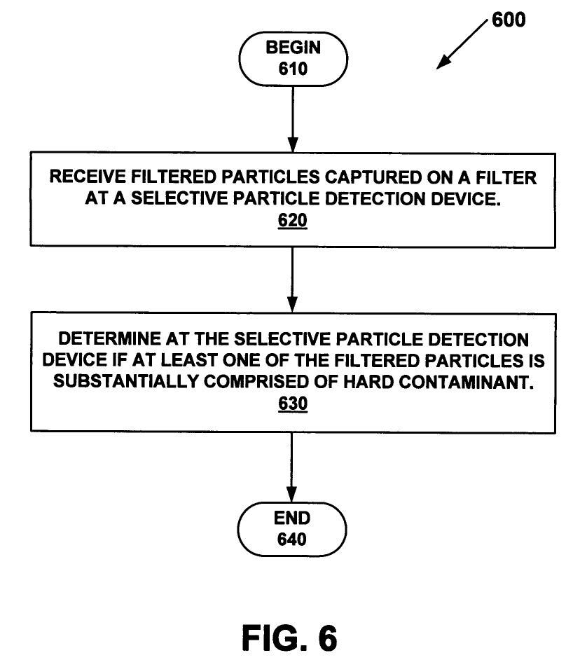

FIG. 6 depicts a flowchart 600 describing a method for determining the cleanliness of a part used in manufacturing by selectively detecting particles substantially comprised of hard contaminant, according to one embodiment of the present invention. Although specific steps are disclosed in flowchart 600, such steps are exemplary. That is, embodiments of the present invention are well suited to performing various other steps or variations of the steps recited in flowchart 600. It is appreciated that the steps in the flowchart 600 may be performed in an order different than presented, and that not all of the steps in flowchart 600 may be performed.

In preparation of the method described by flowchart 600, particles made substantially of hard contaminant can be extracted from a part 230 as described under the subheading “Extracting Hard Particles From a Part.”

At step 610, the method begins

At step 620, filtered particles captured on a filter are received at a selective particle detection device. The filter receiver 510 can receive one or more filters 450 with associated particles. For example, a filter 450 can be mounted on a sticky stub and placed in the device 500. The device 500 can be turned on. Wait until the SEM gun associated with the device and the system vacuum are ready. The acceleration voltage can be set at approximately 5 KV to 30 KV and the beam can be stabilized for approximately 10 minutes.

According to one embodiment, the beam can be moved to stub #1 and BSD can be used to select a filter 450's location at 30x to 50x. The secondary electron detector can be configured to focus the SEM at 2000x. After focusing, BSD can be returned to 100x. The stage location can be added into the stage table. Repeat the process of moving the beam to a stub, selecting a filter 450's location, focusing at approximately 2000x, returning to 100x, and adding the stage location into the stage table for the other stubs.

At step 630, the selective particle detection device determines if at least one of the filtered particles is substantially comprised of hard contaminant. The particle detector 520 can detect whether a particle associated with the filter 450 is a particle substantially made of hard contaminant. Particles associated with the filter 450 can be analyzed using backscatter mode.

For example, the device 500 can be configured to selectively detect particles that are substantially made of hard contaminant. For example, the SEM BSD brightness can be increased until particles made substantially of hard contaminant are visible for example at scan speed=3 or a cycle time of 334 ms. According to one embodiment, this may be accomplished by increasing SEM BSD brightness by approximately 30%-50% over what is conventionally used for detecting and analyzing all of the filtered particles (also known as “full analysis”), whether metallic or hard contaminant. The EDX threshold can be set to 130-220 and the threshold erosion can be set to 1. For more information, the device 500 can be configured using values such as those depicted in Tables 1 and 2 and as described in the subheading “Values for Configuring the Selective Particle Detection Device.” By selectively detecting particles that are substantially made of hard contaminant, detection of particles which are not substantially comprised of hard contaminant is not required. Thus, particle analysis can be performed in approximately 10 minutes instead of several hours.

The SEM screen can be frozen and an image captured using EDX. At the EDX menu bar, the user can click on process, then click on dilate, and then click on erode. The job can be saved with a job name.

At step 640, the method ends.

According to one embodiment, the method described by flowchart 600 provides a “raw number” of particles that it counted. The final number of particles can be calculated based on the raw number of particles as described under the subheading “Calculating Results.” Corrective action can be taken if, for example, the number of particles indicate that the part is not clean enough. For example, the part can be washed one or more additional times.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of determining the cleanliness of a part used in manufacturing by selectively detecting particles substantially comprised of hard contaminant, the method comprising:
receiving filtered particles captured on a filter at a selective particle detection device, wherein the filtered particles were captured from the part; and
determining at the selective particle detection device if at least one of the filtered particles is substantially comprised of hard contaminant, wherein the hard contaminant is selected from a group consisting of silicate, carbide, and ceramic and wherein the determining does not require detecting particles which are not substantially comprised of the hard contaminant.

2. The method as recited in claim 1, wherein the receiving of the filtered particles further comprises:
receiving the filtered particles, wherein the filtered particles were captured from an entity selected from a group consisting of a hard disk drive component and a tool used to manufacture a hard disk drive.

3. The method as recited in claim 1, wherein the determining at the selective particle detection device if at least one of the filtered particles is substantially comprised of the hard contaminate further comprises:
determining at the selective particle detection device if at least one of the filtered particles is substantially comprised of silicon carbide (SiC).

4. The method as recited in claim 1, further comprising:
configuring the selective particle detection device for a brightness that enables the selective particle detection device to detect a filtered particle that is substantially comprised of the hard contaminate without requiring the selective particle detection device to detect the particles which are not substantially comprised of the hard contaminate.

5. The method as recited in claim 1, further comprising:
receiving at the selective particle detection device a value of 1 for a threshold erosion parameter.

6. The method as recited in claim 1, further comprising:
receiving at the selective particle detection device a range of values that are approximately 130-220 for a threshold parameter.

7. The method as recited in claim 1, further comprising:
receiving at the selective particle detection device a range of values that are approximately 0.3 um to 50 um for a threshold size parameter.

8. A hard disk drive that was manufactured using a method of assessing cleanness, the hard disk drive comprising:
a read write head; and
a disk, wherein a selective particle detection device determines if at least one particle from a hard disk drive component is substantially comprised of hard contaminate without requiring detection of particles which are not substantially comprised of the hard contaminate, wherein the hard contaminant is selected from a group consisting of silicate, carbide, and ceramic.

9. The hard disk drive of claim 8, wherein the brightness of the selective particle detection device is configured to be approximately 30-50 percent higher than a brightness used for analyzing all of the filtered particles.

10. The hard disk drive of claim 8, wherein the selective particle detection device receives a value of 1 for a threshold erosion parameter.

11. The hard disk drive of claim 8, wherein the selective particle detection device receives a range of values that are approximately 130-220 for a threshold parameter.

12. The hard disk drive of claim 8, wherein the selective particle detection device receives a range of values that are approximately 0.3 um to 50 um for a threshold size parameter.

13. The hard disk drive of claim 8, wherein a filter has captured particles from the hard disk drive component to enable determining if the at least one particle from the hard disk drive component is substantially comprised of the hard contaminate.

14. The hard disk drive of claim 13, wherein the pore size of the filter is approximately 0.3 um to 0.8 um.

15. A hard disk drive that was manufactured using a method of assessing cleanness, the hard disk drive comprising:
a read write head; and
a disk, wherein a selective particle detection device determines if at least one particle from a tool used to manufacture the hard disk drive is substantially comprised of hard contaminate without requiring detection of particles which are not substantially comprised of the hard contaminate, wherein the hard contaminant is selected from a group consisting of silicate, carbide, and ceramic.

16. The hard disk drive of claim 15, wherein the selective particle detection device is configured with a brightness that enables detecting a filtered particle that is substantially comprised of the hard contaminate without requiring the selective particle detection device to detect the particles which are not substantially comprised of the hard contaminate.

17. The hard disk drive of claim 15, wherein the selective particle detection device receives a value of 1 for a threshold erosion parameter.

18. The hard disk drive of claim 15, wherein the selective particle detection device receives a range of values that are approximately 130-220 for a threshold parameter.

19. The hard disk drive of claim 15, wherein the selective particle detection device receives a range of values that are approximately 0.3 um to 50 um for a threshold size parameter.

20. The hard disk drive of claim 15, wherein a filter includes particles from the hard disk drive component to enable determining if the at least one particle from the hard disk drive component is substantially comprised of the hard contaminate and wherein a spot size on the filter is approximately 2 millimeters (mm) to 3 mms.
